(19) United States
(12) Patent Application Publication
(10) Pub. No.: US 2025/0219448 A1
(43) Pub. Date: Jul. 3, 2025

(54) BIODEGRADABLE WIRELESS CHARGER

(71) Applicant: Valor Communication, Inc., City of Industry, CA (US)

(72) Inventor: Steven Lu, Diamond Bar, CA (US)

(21) Appl. No.: 18/402,590

(22) Filed: Jan. 2, 2024

(51) Int. Cl. H02J 50/00; H02J 50/10

(52) U.S. Cl. CPC H02J 50/005; H02J 50/10

(57) ABSTRACT

A protective case for a mobile device is disclosed. The protective case includes a substantially rigid outer shell and an inner case softer than the outer shell. Both the outer shell and the inner case are made of a compostable and/or biodegradable material. The outer shell includes a first planar back surface, first flanges positioned at least two peripheral edges of the planar back surface for securing the outer shell to the inner case, and open corners for exposing raised corners of the inner case. The inner case includes a second planar back surface, and second flanges around a periphery of the second back surface for securing the inner case to the mobile device. The raised corners are configured to protrude through the open corners of the outer shell.

### TECHNICAL FIELD

The technology discussed below relates generally to wireless chargers for electronic devices.

### BACKGROUND

Wireless chargers allow for the cordless charging of electronic devices, such as smartphones, smartwatches, and other compatible gadgets. Instead of using traditional wired connections, these chargers typically rely on electromagnetic induction or resonant inductive coupling to transfer power from the charging pad to the device's battery. The convenience of eliminating the need for cables and connectors has made wireless chargers increasingly prevalent in public spaces, homes, and workplaces, facilitating a more seamless and effortless charging experience for users.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In various aspects, the present disclosure provides a wireless charger for electronic devices. The housing of the wireless charger is constructed of biodegradable material, such as bamboo. The housing includes two main components: a cover and a shell. A cavity is defined between the cover and the shell that is shaped to house the electronics for the charger. A thickness of the cover and/or shell is configured to allow wireless charging of electronic devices through the biodegradable material, while maintaining structural stability of the housing.

These and other aspects of the disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a plan view of an example wireless charger according to an aspect of this disclosure.

FIG. 2 is an exploded view of an example wireless charger according to an aspect of this disclosure.

FIG. 3 is a top-down plan view of an example shell for the housing of an example wireless charger according to an aspect of this disclosure.

FIG. 4 is an exploded cross-section view of an example housing, including a cover and a shell according to an aspect of this disclosure.

FIG. 5A is a side view of an example wireless charger with a cover flush with a shell according to an aspect of this disclosure.

FIG. 5B is a side view of another example wireless charger with a cover extending from a shell according to an aspect of this disclosure.

FIG. 5C is a side view of another example wireless charger with a contoured cover according to an aspect of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Wireless chargers are a growing industry that improves the user experience when charging electronic devices. However, wireless charger housings tend to be made of plastic materials mainly composed of fossil raw materials (e.g., plastics). Fossil raw materials are non-renewable and cause great consumption of earth resources.

Furthermore, plastic materials are causing ever-increasing damage to the environment through both macro pollution and microplastic proliferation. Plastic materials are not conducive to the sustainable development of the environment. Furthermore, although there are many environmentally friendly and degradable materials in nature, most of them are not suitable for the housing material of wireless chargers.

In various aspects, the present disclosure provides a wireless charger with a housing constructed using compostable and/or biodegradable materials, such as bamboo. The bamboo housing according to the present disclosure is renewable, biodegradable, easy to process, allows for inductive charging with minimal interference, and has sufficient strength and toughness to survive day-to-day use.

In some examples, the wireless charger includes one or more electronic components and a housing surrounding the one or more electronic components. The housing of the wireless charger may be constructed of biodegradable material, such as bamboo or a special wood material (e.g., a hard wood such as mahogany). The housing may include a cover and a shell. A cavity may be defined between the cover and the shell that is shaped to house the one or more electronic components of the wireless charger. The housing may be configured to allow wireless charging of electronic devices through the biodegradable material, while maintaining structural stability of the housing.

For example, in order to allow for wireless charging, the thickness of the housing between the electronic components of the charger and the device to be charged should not be too great. If the material is too thick in this location, it may substantially interfere with the wireless charging (e.g., by induction). However, the housing should be sturdy enough to withstand regular use without breaking due to external forces or warping due to heat. To accomplish this, the fiber direction of the bamboo material in the cover may be substantially perpendicular with the fiber direction of the bamboo material in the shell. For example, when combining a bamboo material (or special wood material) cover with a shell, the fiber direction of the bamboo material in the cover may be arranged vertically, while the fiber direction of the bamboo material in the shell. This may result in a combined structure that is more stable, so that even when the bamboo material cover and shell are very thin (for example, less than 2 mm), the strength of the combined structure is ensured.

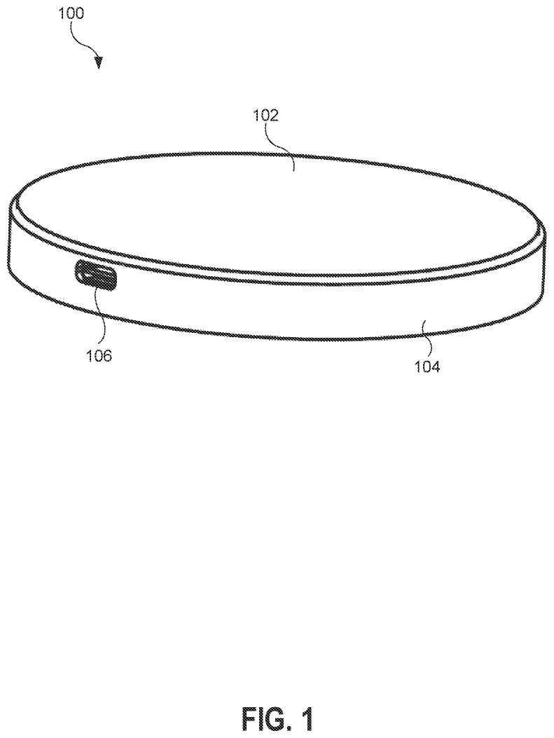

FIG. 1 is a plan view of an example wireless charger 100 according to an aspect of this disclosure. Wireless charger 100 includes cover 102, shell 104, and electronic components 106. The housing in the example of FIG. 1 includes cover 102 and shell 104. Electronic components 106 may include a charging port, shown in the example of FIG. 1 through a power interface (aperture) in shell 104.

Wireless charger 100 may operate to charge compatible electronic devices through one or more methods known in the art. For example, electronic components 106 may include one or more components to charge electronic devices via electromagnetic induction or resonant inductive coupling. Electronic components 106 may generate an alternating magnetic field in e.g., a transmitter coil. A compatible electronic device may include a receiving coil in which an electrical current is induced. Depending on the distance between the transmitting and receiving coils, as well as the materials between the coils, only a fraction of the magnetic flux generated by the transmitting coil may penetrate the receiving coil and provide power transmission. In the example of FIG. 1, electronic components 106 may be configured to generate an alternating magnetic field directed primarily through cover 102 and/or a portion of shell 104.

Electronic components 106 may be disposed in a cavity defined between cover 102 and shell 104. In some examples, cover 102 may take the form of a disk, while shell 104 may be substantially bowl-shaped with one or more distinct chambers forming a cavity. Both cover 102 and shell 104 may be made from a compostable material, for example bamboo. By having cover 102 and shell 104 made from bamboo, wireless charger 100 may be configured to allow wireless charging of electronic devices, while maintaining structural stability. For example, the bamboo of cover 102 and shell 104 may allow for effective induction, that is, not substantially interfere with the changing magnetic field generated by electronic components 106, allowing a current to be induced in a receiving coil of an electronic device for charging the electronic device without substantial energy loss. In some examples, a thickness of cover 102 and/or a portion of shell 104 through which an alternating current is to be generated may be less than ten millimeters. For example, the thickness of cover 102 and/or the portion of shell 104 may be less than or equal to five millimeters, or equal to two millimeters. In some examples, the thickness of cover 102 and/or the shell 104 near the edge of the housing may be less than or equal to 5 mm, and the thickness of the middle portion of cover 102 and/or shell 104 may be less than or equal to 2 mm. In order to maintain structural stability in examples where cover 102 and shell 104 are made from bamboo, the fibers of the bamboo in cover 102 and shell 104 may be substantially perpendicular. Reference to “substantially perpendicular” or “substantially parallel” throughout this disclosure may be understood to allow for manufacturing tolerances in the alignment of the wood fibers during manufacture.

Cover 102 may include a boss or other feature configured to mate with a corresponding channel or groove in shell 104. Cover 102 may attach to shell 104 via the mating between the boss and groove. For example, the boss of cover 102 may occupy the groove of shell 104 to form a tight fit between cover 102 and shell 104, such that cover 102 is held in place relative to shell 104 when the boss occupies the groove.

In some examples, wireless charger 100 may include a biodegradable glue to further attach cover 102 to shell 104. In some examples the biodegradable glue may contact interior surfaces of cover 102 and shell 104. In some examples, the biodegradable glue may be applied in the groove of shell 104 and/or on the boss of cover 102.

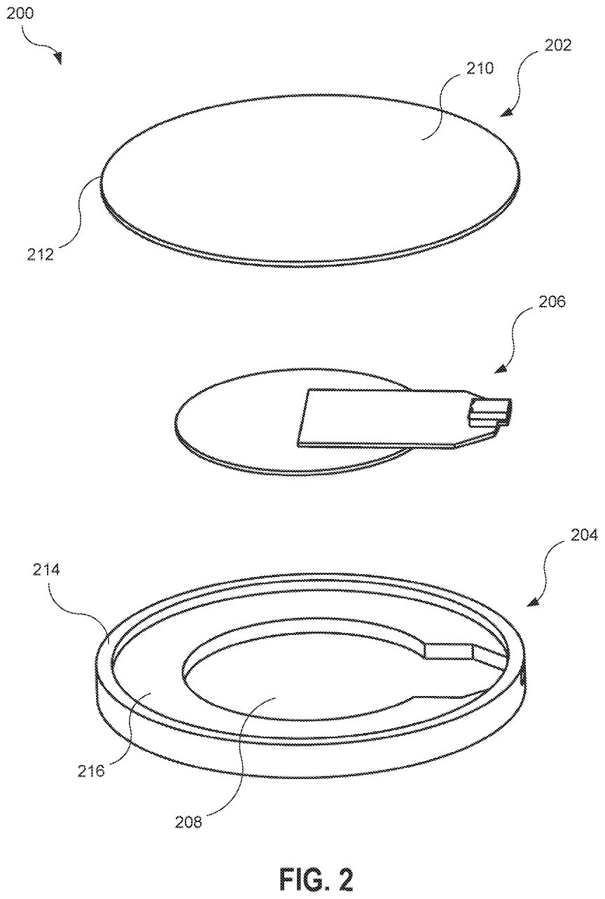

FIG. 2 is an exploded view of example wireless charger 200 according to an aspect of this disclosure. In the example of FIG. 2, wireless charger 200 includes cover 202, shell 204, and electronic components 206. Wireless charger 200, cover 202, shell 204, and electronic components 206 may be substantially similar to their like-named counterparts in FIG. 1.

Shell 204 may include first chamber 208 and second chamber 216. In some examples, first chamber 208 may define a cavity between cover 202 and shell 204 when cover 202 is attached to shell 204. For example, cover 202 may at least partially occupy second chamber 216 when cover 202 is attached to shell 204, and electronic components 206 may at least partially occupy the cavity defined by first chamber 208. In some examples, electronic components 206 may at least partially occupy both first chamber 208 and second chamber 216. In some examples, cover 202 may not occupy second chamber 216. For example, a boss of cover 202 may be disposed on an underside of cover 202 and a groove may be disposed on ridge surface 214 of shell 204 such that when the boss mates with the groove, cover 202 is disposed on top of shell 204.

Cover 202 may include external surface 210. When cover 202 is attached to shell 204, external surface 210 may be configured to face outward from wireless charger 200. In some examples, when cover 202 is attached to shell 204, cover 202 may at least partially occupy second chamber 216, and external surface 210 of cover 202 may be flush with ridge surface 214 of shell 204. For example, perimeter 212 of cover 202 may define a diameter less than or equal to a diameter defined by second chamber 216 and cover 202 may have a thickness less than or equal to a depth of second chamber 216 such that cover 202 is fully disposed within at least a portion of second chamber 216. In some examples, when cover 202 is attached to shell 204, external surface 210 may extend from wireless charger 200 beyond ridge surface 214. For example, cover 202 may have a thickness greater than a depth of second chamber 216 such that when cover 202 at least partially occupies second chamber 216, external surface 210 extends beyond ridge surface 214. In some examples, cover 202 may attach to shell 204 via a groove in ridge surface 214 such that cover 202 sits atop shell 204 and external surface 210 extends from wireless charger 200 beyond ridge surface 214.

First chamber 208 may be configured to snugly fit electronic components 206. For example, a perimeter of electronic components 206 may define a shape substantially similar in size and shape to the size and shape of first chamber 208. Having a close fit between electronic components 206 and first chamber 208 may prevent excessive movement of electronic components 206 within first chamber 208, and thus prevent damage between electronic components 206 and shell 204. First chamber 208 may be shaped to align electronic components 206 with one or more holes in shell 204.

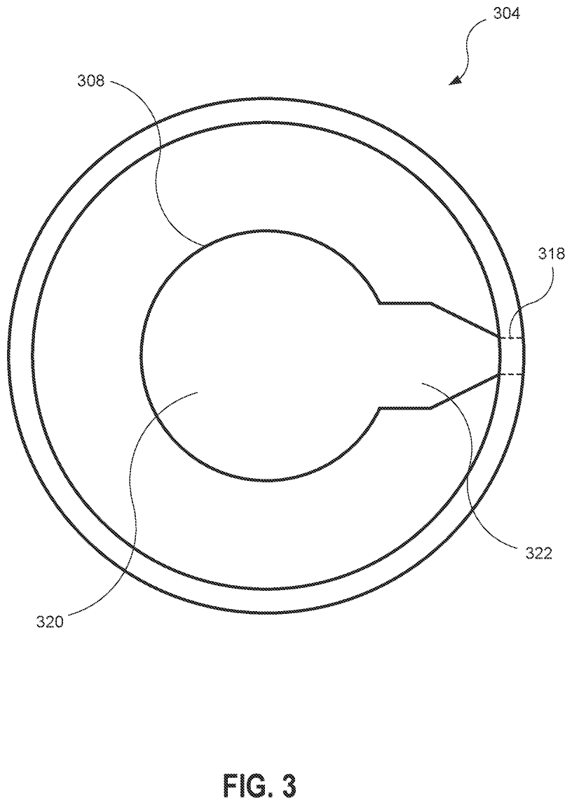

FIG. 3 is a top-down plan view of example shell 304 for the housing of an example wireless charger according to an aspect of this disclosure. Shell 304 may be substantially similar to shell 204 and shell 104 of FIGS. 2 and 1, respectively. Shell 304 may include first chamber 308 and power interface 318. First chamber 308 may be substantially similar to first chamber 208 of FIG. 2.

First chamber 308 may include central portion 320 and extension portion 322. Extension portion 322 may extend from central portion 320 towards a side edge of shell 304. Power interface 318 may consist of a hole or other aperture that extends from a side surface of shell 304 through the side of the shell 304 and into first extension portion 322 of first chamber 308. First chamber 308 may be shaped to align one or more electronic components of the wireless charger power interface 318. For example, first chamber 308 may be shaped to align a charging port with power interface 318. Power interface 318 may be carved, milled, bored, or otherwise machined to form an aperture through shell 304.

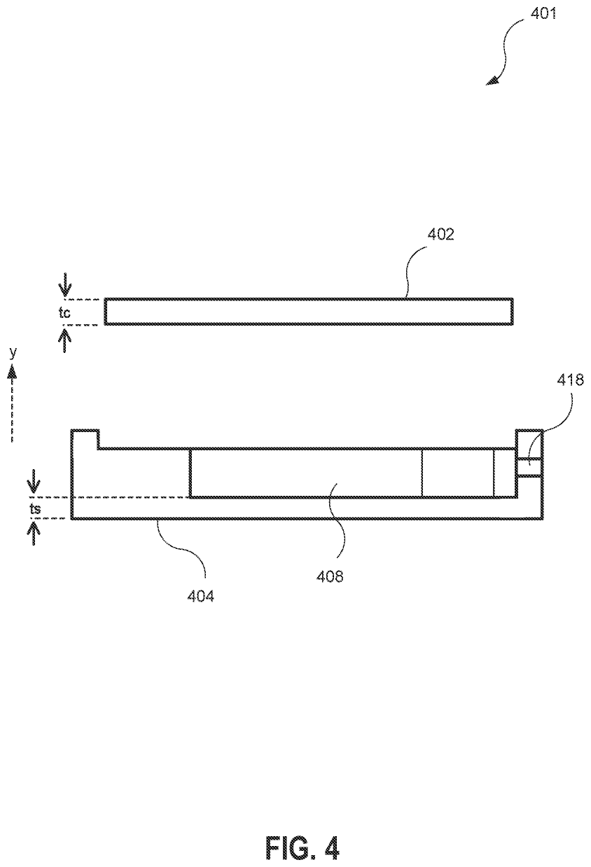

FIG. 4 is an exploded cross-section view of example housing 401, including cover 402 and shell 404 according to an aspect of this disclosure. Shell 404 may include first chamber 408. The cross-section shown in FIG. 4 may be taken along a centerline of housing 401 aligned with power interface 418. Cover 402, shell 404, first chamber 408, and power interface 418 may be substantially similar to their like-named counterparts in earlier figures.

Cover 402 may include a thickness the configured to allow wireless charging of electronic devices through cover 402, while maintaining structural stability of housing 401. Thickness the should be thin enough to minimally or not interfere with magnetic flux generated by electronic components of the wireless charger, while being sturdy enough to withstand day-to-day use over the lifecycle of the wireless charger. For example, to may be less than ten millimeters. In some examples, the may be less than or equal to five millimeters, or equal to two millimeters.

In order to maintain structural stability in examples where cover 402 and shell 404 are made from bamboo, the fibers of the bamboo in cover 402 and shell 404 may be substantially perpendicular. For example, with reference to FIG. 4, when the fibers of cover 402 are substantially parallel to the Y-axis, the fibers of shell 404 may be substantially parallel to the X-axis. Similarly, when the fibers of cover 402 are substantially parallel to the X-axis, the fibers of shell 404 may be substantially parallel to the Y-axis. Housing 401 may be most stable when the fibers of at least one of cover 402 or shell 404 are substantially parallel to a force applied to housing 401. Housing 401 may also be least stable when a force is applied perpendicular to the alignment of the fibers in housing 401. By arranging the fibers of cover 402 and shell 404 such that the fibers of cover 402 are substantially perpendicular to the fibers of shell 404, either the fibers of cover 402 or shell 404 may be substantially parallel to an applied force. For example, cover 402 may include horizontally aligned fibers (e.g., fibers substantially parallel to the y-axis of FIG. 4), and experience a shear force acting on cover 402 in a negative-y direction. Because the fibers of shell 404 may be substantially perpendicular to the fibers of cover 402, the fibers of shell 404 may be substantially parallel to the shear force, providing stability to housing 401 and preventing fracture of housing 401. In some examples, cover 402 may include vertically aligned fibers, and shell 404 may include horizontally aligned fibers. The fibers of the bamboo in cover 403 and/or shell 404 may each define a length substantially parallel to an axis (e.g., the y-axis of FIG. 4). In this way, stresses acting on cover 402 and/or shell 404 in a direction parallel to the fibers of cover 402 and/or shell 404 may be transferred along the length of the fibers, rather than acting to shear the fibers of the bamboo. For example, an electronic device for wireless charging may rest atop cover 402 and apply a force to cover 402 due to gravity, where gravity acts in a negative-y direction in the example of FIG. 4. In some examples, the fibers of the bamboo material of cover 402 and shell 404 may both be aligned substantially vertically, (e.g., substantially parallel with the y-axis), in order to provide the strongest resistance to an expected electronic device resting atop cover 402.

Shell 404 may include a thickness tₛ coextensive with first chamber 408. For example, thickness tₛ may be defined between a bottom surface of shell 404 and an interior surface of shell 404 closest to the bottom surface and substantially parallel to the bottom surface. The interior surface closest to the bottom surface of shell 404 may be defined by first chamber 408. In the example of FIG. 4, thickness tₛ may be configured to allow wireless charging of electronic devices through the portion of shell 404 coextensive with first chamber 408, while maintaining structural stability of housing 401. Thickness tₛ should be thin enough to minimally or not interfere with magnetic flux generated by electronic components of the wireless charger, while being sturdy enough to withstand day-to-day use over the lifecycle of the wireless charger. For example, tₛ may be less than ten millimeters. In some examples, tₛ may be less than or equal to five millimeters, or equal to two millimeters.

Cover 402 and shell 404 may be made of biodegradable material. In some examples a both thickness t_{c} and tₛ are configured to allow wireless charging of electronic devices through the biodegradable material, while maintaining structural stability of the housing. In some examples, only one of thickness t_{c} or tₛ is configured to allow wireless charging of electronic devices through the biodegradable material, while maintaining structural stability of the housing. For example, t_{c} may be equal to two millimeters, while thickness tₛ is large enough to prevent effective inductive charging of an electronic device through thickness tₛ.

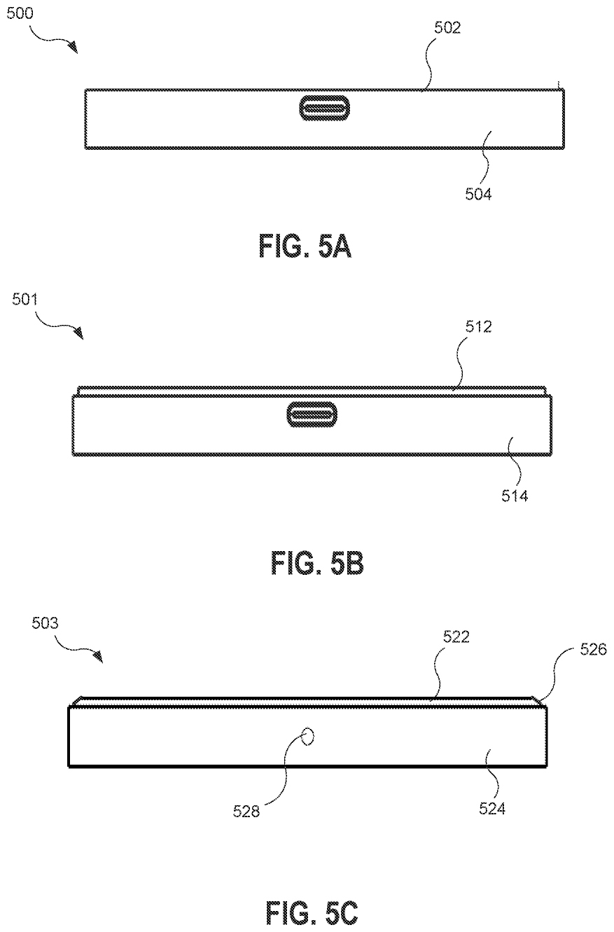

FIG. 5A is a side view of example wireless charger 500 with cover 502 flush with shell 504 according to an aspect of this disclosure. Wireless charger 500, cover 502, and shell 504 may be substantially similar to their like-named counterparts in earlier figures.

In some examples, when cover 502 is attached to shell 504, cover 502 may at least partially occupy an opening in shell 504, and an external surface of cover 502 may be flush with an external surface of shell 504. For example, a diameter defined by cover 502 may be less than or equal to a diameter defined by an opening in shell 504 and cover 502 may have a thickness less than or equal to a depth of the opening such that cover 502 is fully disposed within at least a portion of the opening.

FIG. 5B is a side view of another example wireless charger 501 with cover 512 extending from shell 514 according to an aspect of this disclosure. Wireless charger 501, cover 512, and shell 514 may be substantially similar to their like-named counterparts in earlier figures.

In some examples, when cover 512 is attached to shell 514, an external surface of cover 512 may extend from wireless charger 501 beyond a ridge surface of shell 514. For example, cover 512 may have a thickness greater than a depth of an opening in shell 514 that cover 512 at least partially occupies. In some examples, an internal surface of cover 512 opposite the external surface may be attached to the ridge surface of shell 514 as described with respect to FIG. 2. In some examples, a height of wireless charger 501 may be around ten millimeters (e.g., 9.5 mm). In some examples a width (diameter) of wireless charger 501 may be around ninety millimeters (e.g., 90.5 mm).

FIG. 5C is a side view of another example wireless charger 503 with a contoured cover 522 according to an aspect of this disclosure. Wireless charger 503 and shell 524 may be substantially similar to their like-named counterparts in earlier figures.

In some examples, when cover 522 is attached to shell 524, an external surface of cover 522 may extend from wireless charger 503 beyond a ridge surface of shell 524 as described above. Cover 522 may include a countered perimeter 526 to provide a smooth transition between an external surface of cover 522 and an external surface (e.g., a ridge surface) of shell 524. For example, an edge of the ridge surface of shell 524 in contact with an edge of the external surface of cover 522 may be aligned to prevent a stepped transition between the ridge surface and the external surface. The contoured perimeter may then gradually elevate the external surface of cover 522 away from the ridge surface. The contoured perimeter 526 may be chamfered, rounded, or otherwise shaped to provide the smooth transition.

A cavity inside wireless charger 503 may be shaped to align electronic components of wireless charger 503 with one or more holes in shell 524. For example, the cavity may be shaped to align a power indicator (e.g., an LED) with aperture 528. Aperture 528 may be carved, milled, bored, or otherwise machined to through shell 524 from the exterior of shell 524 to the interior cavity.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object.

One or more of the components, steps, features and/or functions illustrated in FIGS. 1-5 may be rearranged and/or combined into a single component, step, feature or function or embodied in several components, steps, or functions. Additional elements, components, steps, and/or functions may also be added without departing from novel features disclosed herein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A wireless charger, comprising:
one or more electronic components; and
a housing comprising:
a cover; and
a shell, wherein the one or more electronic components are disposed within a cavity defined between the cover and the shell, and wherein the cover and the shell both comprise a biodegradable bamboo material.

2. The wireless charger of claim 1, wherein the shell comprises a groove, wherein the cover comprises a boss carved to match the groove in the shell, and wherein the boss of the cover occupies the groove in the shell to attach the cover to the shell.

3. The wireless charger of claim 1, wherein a thickness of the cover is less than 2 mm.

4. The wireless charger of claim 1, wherein a thickness of the shell in a region coextensive with the cavity is less than 2 mm.

5. The wireless charger of claim 1, wherein the biodegradable bamboo material comprises a series of fibers, wherein fibers of the biodegradable bamboo material in the cover are substantially perpendicular to fibers of the biodegradable bamboo material in the shell.

6. The wireless charger of claim 1, wherein the shell comprises a first chamber and a second chamber, wherein the first chamber defines the cavity between the cover and the shell when the cover is attached to the shell, and wherein the cover occupies the second chamber when the cover is attached to the shell.

7. The wireless charger of claim 6, wherein the cover fully occupies the second chamber such that an external surface of the cover is flush with a ridge surface of the shell when the cover is attached to the shell.

8. The wireless charger of claim 1, wherein an external surface of the cover extends beyond a ridge surface of the shell when the cover is attached to the shell, wherein a perimeter of the external surface is contoured to provide a smooth transition between the ridge surface and the external surface.

9. The wireless charger of claim 1, wherein the cavity is sized to snugly fit the one or more electronic components, wherein the shell comprises a power interface carved into a side of the shell, and wherein the power interface extends from a side surface of the shell through the side of the shell and to the cavity.

10. A housing for a wireless charger, comprising:
a cover comprising a biodegradable bamboo material; and
a shell comprising:
the biodegradable bamboo material, wherein fibers of the biodegradable bamboo material in the cover are substantially perpendicular to fibers of the biodegradable bamboo material in the shell;
a first chamber, wherein the first chamber defines a cavity between the cover and shell when the cover is attached to the shell, and wherein the cavity is sized to snugly fit electronic components of the wireless charger; and
a second chamber, wherein the cover occupies the second chamber when the cover is attached to the shell,
wherein a thickness of either the cover or the shell is configured to allow wireless charging of electronic devices through the thickness while maintaining a structural stability of the housing.
